(19) United States
(12) Patent Application Publication
(10) Pub. No.: US 2023/0239723 A1
(43) Pub. Date: Jul. 27, 2023

(54) CHANNEL ACCESS USING AN INTELLIGENT REFLECTING SURFACE

(71) Applicant: QUALCOMM Incorporated, San Diego, CA (US)

(72) Inventors: Mehmet Izzet GURELLI, San Diego, CA (US); Qiang WU, San Diego, CA (US); Junyi LI, Fairless Hills, PA (US); Tao LUO, San Diego, CA (US); Navid ABEDINI, Basking Ridge, NJ (US); Ozge KOYMEN, Princeton, NJ (US)

(21) Appl. No.: 17/648,864

(22) Filed: Jan. 25, 2022

(51) Int. Cl. H04W 28/02; H04B 7/155; H04W 28/04; H04L 5/00; H04W 72/12

(52) U.S. Cl. CPC H04W 28/0236; H04B 7/15507; H04W 28/04; H04L 5/0048; H04L 5/0005; H04W 72/1278

(57) ABSTRACT

Certain aspects of the present disclosure provide techniques for channel access using an intelligent reflecting surface (IRS). A method that may be performed by a network entity includes monitoring candidate paths for channel access, wherein the candidate paths include one or more paths through an intelligent reflecting surface; determining at least one path among the candidate paths for communications with a first wireless node based at least in part on one or more criteria associated with the candidate paths and obtained from monitoring the candidate paths; and communicating with the first wireless node via the at least one path.

### BACKGROUND

Aspects of the present disclosure relate to wireless communications, and more particularly, to techniques for wirelessly communicating with an intelligent reflecting surface.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include improved wireless communication performance, for example, in an unlicensed or shared spectrum.

Certain aspects of the subject matter described in this disclosure can be implemented in a method for wireless communication by a network entity. The method generally includes monitoring candidate paths for channel access, wherein the candidate paths include one or more paths through an intelligent reflecting surface; determining at least one path among the candidate paths for communications with a first wireless node based at least in part on one or more criteria associated with the candidate paths and obtained from monitoring the candidate paths; and communicating with the first wireless node via the at least one path.

Certain aspects of the subject matter described in this disclosure can be implemented in a method for wireless communication by a first wireless node. The method generally includes receiving, from a network entity, signaling indicating candidate paths for channel access, wherein the candidate paths include one or more paths through an intelligent reflecting surface; measuring one or more properties associated with the candidate paths; transmitting, to the network entity, a first indication of the one or more properties, a second indication of one or more preferred paths among the candidate paths, or a combination thereof; and communicating with the network entity via at least one of the candidate paths.

Certain aspects of the subject matter described in this disclosure can be implemented in an apparatus for wireless communication. The apparatus generally includes a memory and a processor coupled to the memory. The processor and the memory are configured to monitor candidate paths for channel access, wherein the candidate paths include one or more paths through an intelligent reflecting surface, determine at least one path among the candidate paths for communications with a first wireless node based at least in part on one or more criteria associated with the candidate paths and obtained from monitoring the candidate paths, and communicate with the first wireless node via the at least one path.

Certain aspects of the subject matter described in this disclosure can be implemented in an apparatus for wireless communication. The apparatus generally includes a memory and a processor coupled to the memory. The processor and the memory are configured to receive, from a network entity, signaling indicating candidate paths for channel access, wherein the candidate paths include one or more paths through an intelligent reflecting surface, measure one or more properties associated with the candidate paths, transmit, to the network entity, a first indication of the one or more properties, a second indication of one or more preferred paths among the candidate paths, or a combination thereof, and communicate with the network entity via at least one of the candidate paths.

Certain aspects of the subject matter described in this disclosure can be implemented in an apparatus for wireless communication. The apparatus generally includes means for monitoring candidate paths for channel access, wherein the candidate paths include one or more paths through an intelligent reflecting surface; means for determining at least one path among the candidate paths for communications with a first wireless node based at least in part on one or more criteria associated with the candidate paths and obtained from monitoring the candidate paths; and means for communicating with the first wireless node via the at least one path.

Certain aspects of the subject matter described in this disclosure can be implemented in an apparatus for wireless communication. The apparatus generally includes means for receiving, from a network entity, signaling indicating candidate paths for channel access, wherein the candidate paths include one or more paths through an intelligent reflecting surface; means for measuring one or more properties associated with the candidate paths; means for transmitting, to the network entity, a first indication of the one or more properties, a second indication of one or more preferred paths among the candidate paths, or a combination thereof; and means for communicating with the network entity via at least one of the candidate paths.

Certain aspects of the subject matter described in this disclosure can be implemented in a computer-readable medium. The computer-readable medium has instructions stored thereon for monitoring candidate paths for channel access, wherein the candidate paths include one or more paths through an intelligent reflecting surface; determining at least one path among the candidate paths for communications with a first wireless node based at least in part on one or more criteria associated with the candidate paths and obtained from monitoring the candidate paths; and communicating with the first wireless node via the at least one path.

Certain aspects of the subject matter described in this disclosure can be implemented in a computer-readable medium. The computer-readable medium has instructions stored thereon for receiving, from a network entity, signaling indicating candidate paths for channel access, wherein the candidate paths include one or more paths through an intelligent reflecting surface; measuring one or more properties associated with the candidate paths; transmitting, to the network entity, a first indication of the one or more properties, a second indication of one or more preferred paths among the candidate paths, or a combination thereof; and communicating with the network entity via at least one of the candidate paths.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment (UE).

FIGS. 3A-3D depict various example aspects of data structures for a wireless communication network.

FIG. 4A and FIG. 4B are diagrams illustrating example vehicle-to-everything communication systems.

FIG. 5 is a schematic diagram illustrating an example network of multiple cellular vehicle-to-everything (CV2X) devices operating in an unlicensed spectrum.

FIG. 6 illustrates an example of using an intelligent reflecting surface (IRS) in a wireless communications network.

FIG. 7 is a diagram illustrating an example wireless communication network where IRSs are used to provide channel access among wireless nodes in an unlicensed spectrum.

FIG. 8 is a signaling flow illustrating example signaling for providing channel access via one or more IRSs.

FIG. 9 is a flow diagram illustrating example operations for wireless communication, for example, by a network entity.

FIG. 10 is a flow diagram illustrating example operations for wireless communication, for example, by a wireless node.

FIG. 11 depicts aspects of an example communications device.

FIG. 12 depicts aspects of an example communications device.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatuses, methods, processing systems, and computer-readable mediums for channel access in an unlicensed spectrum using an intelligent reflecting surface (IRS).

In an unlicensed or shared spectrum, various channel access procedures may be used to share the channel among multiple wireless device. For example, a wireless device may use a listen-before-talk procedure to determine whether the channel is busy (e.g., occupied) or idle before transmitting on the channel. Despite the listen-before-talk procedure or other channel access procedures, a wireless device may encounter interference from other wireless devices, for example, due to there being interfering transmissions at the receiver not detected by the transmitter during the listen-before-talk procedure.

Aspects of the present disclosure provide techniques and apparatus for providing channel access in an unlicensed spectrum using an IRS. For example, a first wireless node may select a communication path between the first wireless node and a second wireless node through an IRS. The IRS may provide an alternative path for communications between the first wireless node and the second wireless node. The communication path may provide access to an idle channel (or a channel with reduced occupancy, interference, and/or noise) at the receiving entity, for example, due to the different receive beamforming used to receive signals on the communication path. The first wireless node may select the communication path based on various criteria, such as channel measurements, channel occupancy, radio frequency emissions, etc.

The techniques and apparatus for IRS-based channel access described herein may enable improved wireless communication performance, such as reduced latencies and/or increased throughput, for example, due to an IRS providing a communication path with reduced interference or no interference from other wireless devices.

Example wireless communications in an unlicensed or shared spectrum include vehicle-to-everything (V2X) communications and/or device-to-device (D2D) communications. Though certain aspects may be discussed with respect to V2X communications in a V2X communications system, it should be noted that the aspects may equally apply to other suitable types of shared spectrum communications systems. An unlicensed or shared spectrum refers to any frequency band(s) that are not subject to licensed use under regulatory practice, such that the frequency band(s) are open to use by any devices, and not just devices that have a license to use the particular frequency band(s).

### Introduction to Wireless Communication Networks

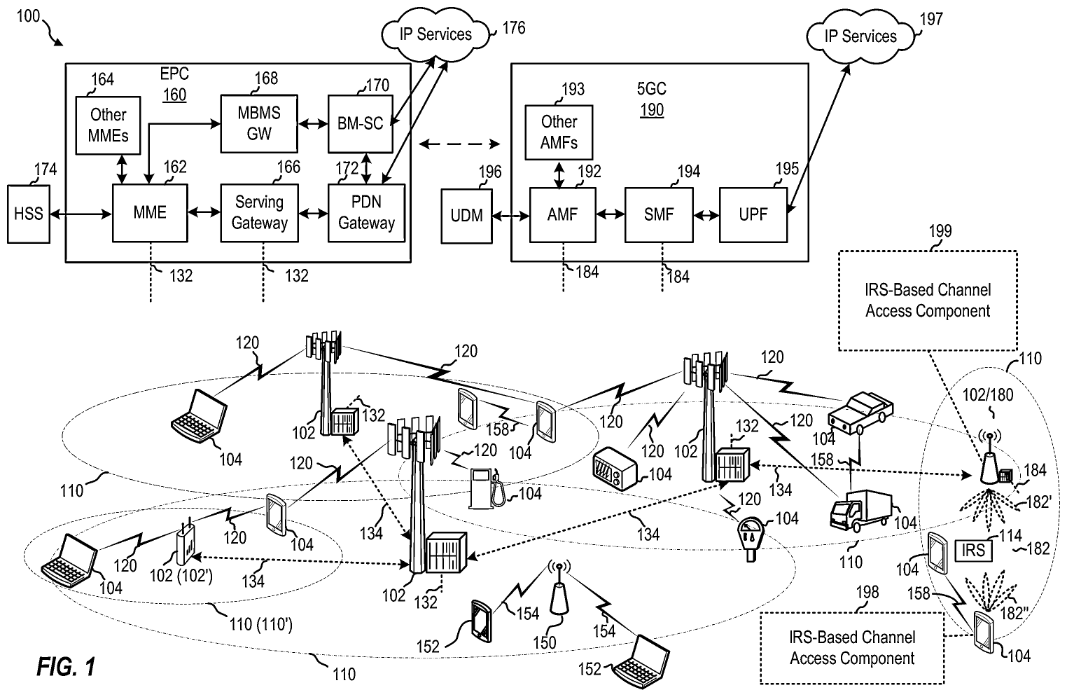

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

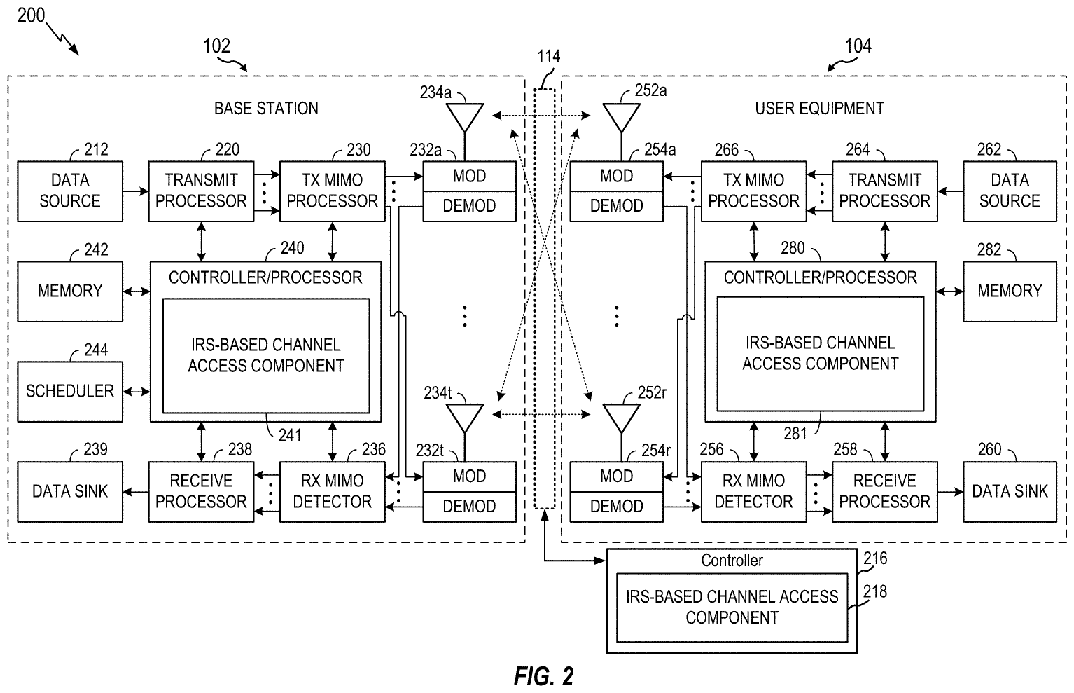

In certain aspects, the base station 102 and user equipment 104 may communicate through an intelligent reflecting surface (IRS) 114, for example, when a line-of-sight path between the base station 102 and the user equipment 104 is obstructed by an obstacle or when the channel capacity or channel quality in the line-of-sight path is relatively low. In certain cases, multiple user equipment 104 may communicate with each other through the IRS 114. The IRS 114 may serve as a reflector for wireless communications. The IRS 114 may use a codebook for precoding one or more elements (e.g., antenna elements or meta-surface elements) thereon (referred to as reflection elements) to allow a beam from the base station 102 (e.g., a transmitter) to be re-radiated off the IRS 114 to reach the user equipment 104 (e.g., a receiver), or vice versa. A reflection controller (as further described herein with respect to FIG. 2) may control or reconfigure the spatial direction of the re-radiation (e.g., the beamforming) at the IRS 114. The term “intelligent reflecting surface” can refer to any suitable reconfigurable reflecting device in a range of reflecting devices, such as a reconfigurable intelligent surface (RIS), reflectarray, meta-surface, etc.

Wireless communication network 100 includes an IRS-based channel access component 199, which may determine communications paths through an IRS and communicate with a UE using the communication paths. Wireless network 100 further includes an IRS-based channel access component 198, which may communicate with a network entity using communication paths through an IRS.

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes an IRS-based channel access component 241, which may be representative of the IRS-based channel access component 199 of FIG. 1. Notably, while depicted as an aspect of controller/processor 240, the IRS-based channel access component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes an IRS-based channel access component 281, which may be representative of IRS-based channel access component 198 of FIG. 1. Notably, while depicted as an aspect of controller/processor 280, the IRS-based channel access component 281 may be implemented additionally or alternatively in various other aspects of user equipment 104 in other implementations.

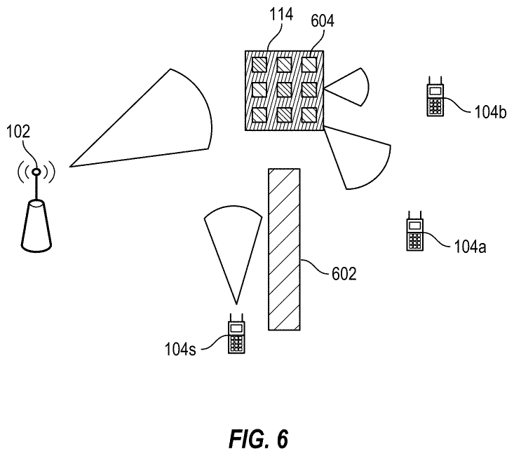

The IRS 114 may be configured or controlled by a controller 216. Reflection elements may re-radiate radio signals between the UE and BS with certain phase shifts or amplitude changes as controlled by the controller 216. The controller 216 may reconfigure the phase or amplitude changes by applying a precoding weight to reflection elements to enable the IRS 114 to re-radiate an output beam at different directions (e.g., elevation and/or azimuth) given a particular input beam. An illustrative deployment example of the IRS 114 is shown in FIG. 6. According to the present disclosure, the controller 216 includes an IRS-based channel access component 218 that may reflect or re-radiate signals between the UE and BS, in accordance with aspects described herein.

While the controller 216 is depicted as a separate network entity in communication with the IRS 114 to facilitate understanding, aspects of the present disclosure may be applied to the controller 216 being integrated or co-located with the IRS 114, the BS 102, and/or another UE.

While the user equipment 104 is described with respect to FIGS. 1 and 2 as communicating with a base station and/or within a network, the user equipment 104 may be configured to communicate directly with/transmit directly to another user equipment 104, or with/to another wireless device without relaying communications through a network. In some aspects, the base station 102 illustrated in FIG. 2 and described above is an example of another user equipment 104.

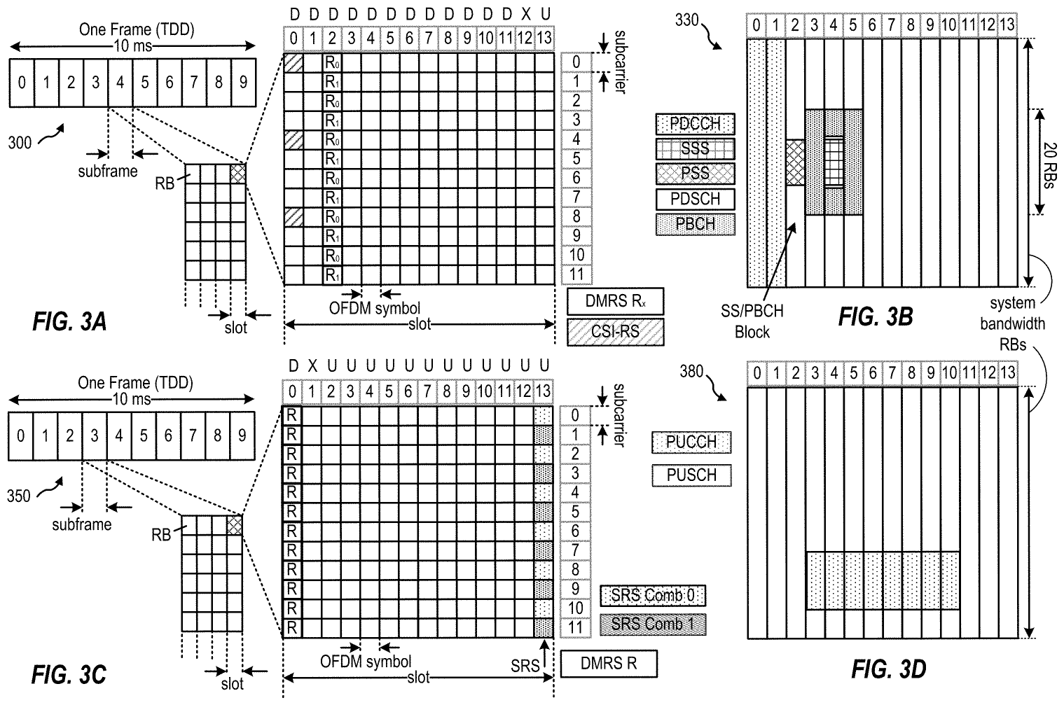

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL

Further discussions regarding FIG. 1, FIG. 2, and FIGS. 3A-3D are provided later in this disclosure.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5G networks may utilize several frequency ranges, which in some cases are defined by a standard, such as the 3GPP standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

Further, as described herein, wirelessly communicating with an intelligent reflecting surface may use beamforming in mmWave bands and/or other frequency bands.

### Example V2X Systems

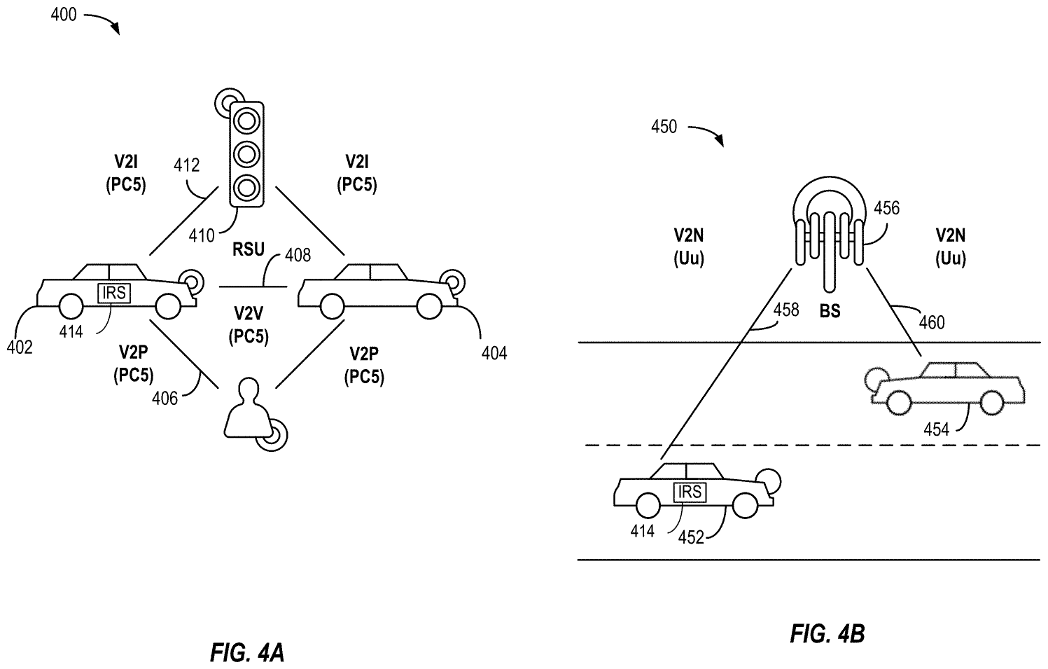

Wireless communications in an unlicensed spectrum may include vehicle-to-everything (V2X) communications. FIG. 4A and FIG. 4B show diagrammatic representations of example V2X systems, in accordance with some aspects of the present disclosure. For example, the vehicles shown in FIG. 4A and FIG. 4B may communicate via sidelink channels and may relay sidelink transmissions as described herein. The V2X systems, may be examples of sidelink communication systems discussed herein, and the vehicles and other devices may be configured to communicate over sidelink frequency channels as discussed herein.

The V2X systems provided in FIG. 4A and FIG. 4B provide two complementary transmission modes. A first transmission mode (also referred to as mode 4), shown by way of example in FIG. 4A, involves direct communications (for example, also referred to as sidelink communications) between participants in proximity to one another in a local area. A second transmission mode (also referred to as mode 3), shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle-to-vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 460 may be used, for example, for long-range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

In certain aspects, an IRS 414 may be deployed in the V2X system 400, 450. For example, an IRS 414 may be arranged on a vehicle (402, 452) and/or other objects to facilitate reflection/refraction of wireless transmissions, as further described herein.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NodeB-type RSUs have similar functionality as a Macro eNB or gNB. The Micro NodeB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

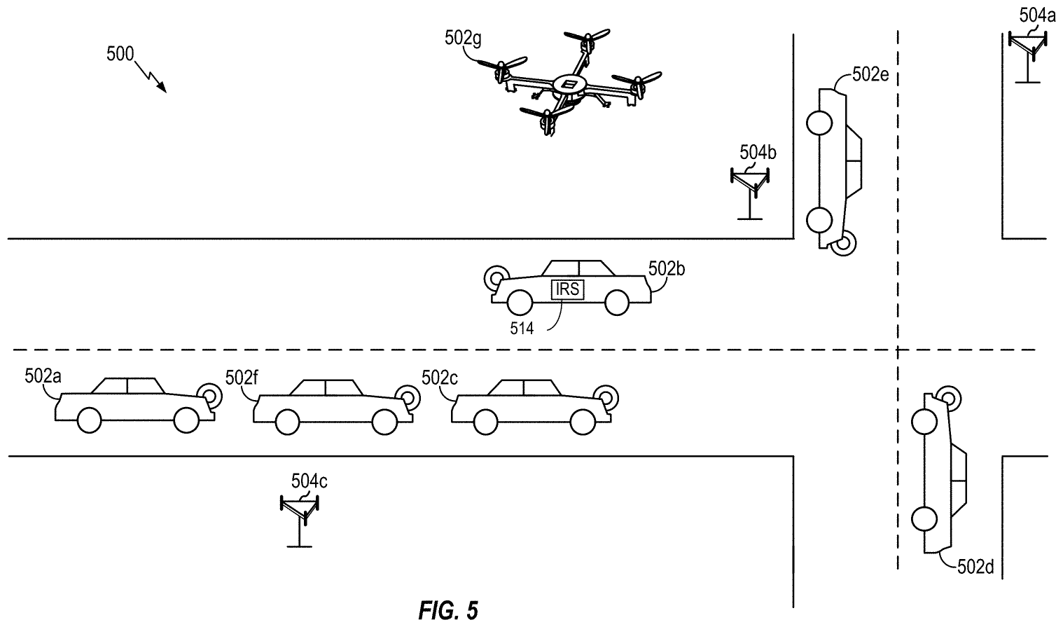

FIG. 5 is a schematic diagram illustrating an example network 500 of multiple cellular vehicle-to-everything (CV2X) devices operating in an unlicensed spectrum. The unlicensed spectrum may be an example of a sidelink frequency band. An unlicensed band in an unlicensed spectrum refers to any frequency band(s) that are not subject to licensed use under regulatory practice, such that they are open to use by any devices, and not just devices that have a license to use the particular frequency band(s). Further, the network 500 may be an example of a sidelink communication system. The CV2X devices 502 may be configured to communicate on sidelink frequency channels as discussed herein. For example, any of the CV2X devices 502 may communicate with any other of the CV2X devices 502.

In the illustrated example, seven CV2X devices (e.g., a first CV2X device 502a, a second CV2X device 502b, a third CV2X device 502c, a fourth CV2X device 502d, a fifth CV2X device 502e, a sixth CV2X device 502f, and a seventh CV2X device 502g)—collectively referred to as CV2X devices 502) may operate in an unlicensed spectrum with other non-CV2X devices (e.g., non-CV2X devices 504a-c—collectively referred to as non-CV2X devices 504). In some examples, the first CV2X device 502a, the sixth CV2X device 502f, and the third CV2X device 502c may be part of a fleet or platoon. In transportation, platooning or flocking is a method for driving a group of vehicles together. It is meant to increase the capacity of roads via an automated highway system. Platoons decrease the distances between cars or trucks, such as based on SL communications.

Although the example provided is illustrative of six automotive CV2X devices in a traffic setting and a drone or other aerial vehicle CV2X device, it can be appreciated that CV2X devices and environments may extend beyond these, and include other wireless communication devices and environments. For example, the CV2X devices 502 may include UEs (e.g., UE 120 of FIG. 1) and/or road-side units (RSUs) operated by a highway authority, and may be devices implemented on motorcycles or carried by users (e.g., pedestrian, bicyclist, etc.), or may be implemented on another aerial vehicle such as a helicopter.

The CV2X devices 502 may include UEs (e.g., UE 120 of FIG. 1), and may be devices implemented on motorcycles or carried by users (e.g., pedestrian, bicyclist, etc.), or implemented as a roadside unit.

In certain aspects, an IRS 514 may be deployed in the network 500. For example, the IRS 506 may be arranged on a CV2X device 502 and/or other objects to facilitate reflection/refraction of wireless transmissions, as further described herein.

### Introduction to Communications with an Intelligent Reflecting Surface

An intelligent reflecting surface (IRS) may be deployed to reflect electromagnetic waves in specified directions (e.g., azimuth and/or elevation) based on electrical control applied across the IRS. An IRS may be considered a surface that includes densely packed, very small surface elements (e.g., reflecting elements). Each surface element has a controllable reflection coefficient, by which the phase-shift between the incident and reflected rays to/from the surface element can be controlled.

By properly setting the surface phase (e.g., the phases of reflection coefficients of certain surface elements), a downlink beam from a base station (BS) can be reflected from the IRS towards a user equipment (UE) or vice versa in the uplink. An IRS may help reduce path loss and/or avoid blockages in the line-of-sight propagation as further described herein.

An IRS can provide directional control of the reflected wave/beam and introduce lower losses due to reflection compared to other reflectors (e.g., a wall or passive repeater). In some cases, an IRS may operate without substantial power consumption when the IRS operates passively to reflect or refract beams from a transmitter toward a receiver. In some cases, the reflection or refraction direction of an IRS may be controlled by a controller, such as a base station, network controller, or a UE (e.g., a sidelink monitoring UE). An IRS may be implemented in sidelink communications, e.g., vehicle-to-everything and/or device-to-device (D2D) communications.

An IRS can alter the nature of the communication environment. An IRS may enable the reflection of transmission around a blockage, especially in mmWave bands, for example, as described herein with respect to FIG. 6. In certain cases, the direct path may be weak due to blockage, where the path through the IRS is dominant (as reflection losses may be minimal). An IRS may enable signal enhancement through additional signal paths (e.g., a line of sight path from a transmitter and an indirect path from a IRS) to a UE. For example, the IRS may adjust the reflected wave to constructively enhance with a line of sight signal at the receiver.

FIG. 6 illustrates an example of using an IRS (such as the IRS 114 of FIGS. 1 and 2) to overcome blockage 602 in a wireless communications network. As shown, an IRS 114 may be arranged to reflect or otherwise re-radiate the radio signals from the BS 102 to bypass the blockage 602. For example, the two-way communications between the BS 102 and the UE 104a may be enabled by the IRS 114 re-radiating one or more beams from the BS 102 toward the UE 104a, or vice versa. Furthermore, the IRS 114 can also be configured (e.g., directing incoming and outgoing beams at different angles) to enable the UEs 104s and 104a to communicate via sidelink channels, for example, around the blockage 602.

The IRS 114 may perform passive beamforming. For example, the IRS 114 may receive signal power from the transmitter (e.g., the BS 102, UE 104a, or UE 104s) proportional to a number of reflecting elements 604 thereon. In certain cases, the reflecting elements can be referred to as surface elements or meta-atoms. When the IRS reflects or refracts the radio signal, the reflecting elements 604 cause phase shifts to perform conventional beamforming or precoding. The phase shifts may be controlled by precoding weights (e.g., a multiplier or an offset of time delay) applied to the reflecting elements. For an array of reflecting elements, such as an m×n rectangular matrix, for example, a respective precoding weight may be generated or specified for each of the reflecting elements by a controller. In certain aspects, the IRS 114 may be implemented as a reflectarray with a passive antenna array, such that the reflecting element 604 may be implemented as an antenna coupled to a phase shifter. In certain aspects, the IRS 114 may be implemented with metasurfaces, such that the reflecting element 604 may be implemented as a reconfigurable metasurface that can impose an amplitude and/or phase profile on an incident RF signal. The reflecting elements can be controlled to reflect an incident electromagnetic wave in a desired direction (e.g., azimuth and/or elevation) and/or with a desired beamwidth.

### Aspects Related to Channel Access Using an Intelligent Reflecting Surface

Aspects of the present disclosure provide techniques and apparatus for providing channel access in an unlicensed spectrum using an IRS. For example, a first wireless node may select a communication path between the first wireless node and a second wireless node through an IRS. The IRS may provide an alternative path for communications between the first wireless node and the second wireless node. The communication path may provide access to an idle channel (or a channel with reduced occupancy, interference, and/or noise) at the receiving entity, for example, due to the different receive beamforming used to receive signals on the communication path. The first wireless node may select the communication path based on various criteria, such as channel measurements, channel occupancy, radio frequency emissions, etc.

The techniques and apparatus for IRS-based channel access described herein may enable improved wireless communication performance, such as reduced latencies and/or increased throughput, for example, due to an IRS providing a communication path with an idle channel (or a channel with reduced occupancy, interference, and/or noise).

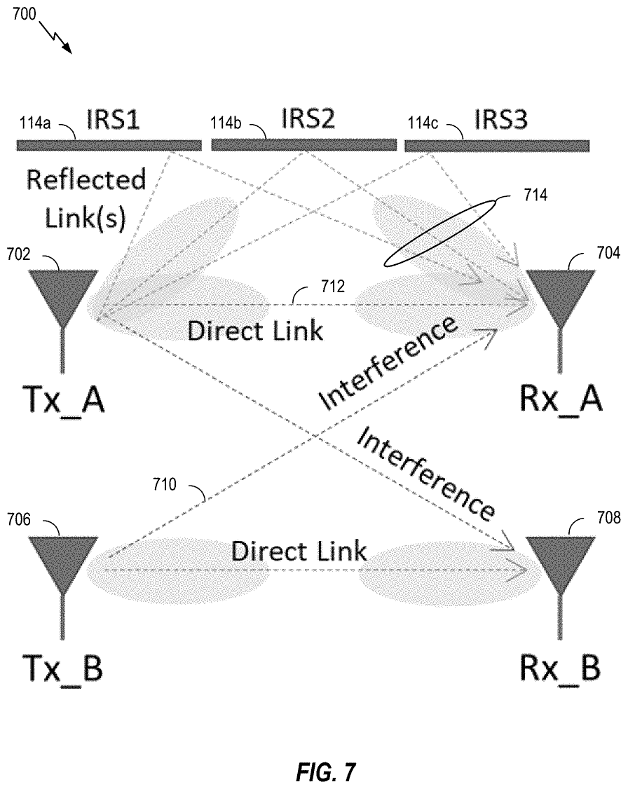

FIG. 7 is a diagram illustrating an example wireless communication network 700 where IRSs 114a-c may be used to provide channel access among wireless nodes, for example, in an unlicensed spectrum. In this example, a first wireless node 702 may have data to transmit to a second wireless node 704. In certain cases, the second wireless node 704 may encounter interference, for example, from interfering signals 710 transmitted by a third wireless node 706 to a fourth wireless node 708. The interference from the third wireless node may degrade the signal quality of received signals at the second wireless node 704 on a direct path 712 (e.g., a line-of-sight path) from the first wireless node 702 to the second wireless node 704. The first wireless node 702 may select a path among candidate paths for communications with the second wireless node 704, where the candidate paths may include the direct path (or link) 712 and reflected paths (or links) 714 through the IRSs 114a-c. The reflected path 714 may include an indirect signal path between the first wireless node 702 and the second wireless node 704 with a point of incidence at an IRS 114. The first wireless node 702 may select one or more of the reflected paths 714 through the IRSs 114a-c to communicate with the second wireless node 704 due to the reflected paths 714 providing the highest signal quality at the second wireless node 704.

Signals on the reflected paths 714 may be received at the second wireless node 704 with different angles of arrival than signals on the direct path 712 and/or the interfering signal 710. In such cases, the second wireless node 704 may use a spatial filter to receive signals on the reflected paths 714 from the first wireless node 702 with reduced interference or no interference from the third wireless node 706. The reflected paths 714 through the IRSs 114a-c may provide alternative paths with improved signal quality at the second wireless node 704.

In certain aspects, the IRSs 114a-c may be arranged in various orientations and/or locations to provide communication paths across a range of directions. For example, suppose the IRSs 114a-c are located in a building or structure, for example, an airport or train station, cafeteria, food court, conference room, concert hall, or stadium. The first and second IRSs 114a, 114b may be arranged on opposite walls of the building, and the third IRS 114c may be arranged on the ceiling of the building. In certain cases, the IRSs 114a-c may be located outdoors, for example, in a park, courtyard, garden, or zoo. Each of the IRSs 114a-c may be arranged in different locations and/or at different heights outdoors, for example. The radiated power (e.g., an effective isotropic radiated power (EIRP)) of an IRS may be considered in determining the location and/or orientation of the IRS. For example, an IRS may be positioned at a sufficient distance from a transmitting entity (e.g., a base station) as to prevent the IRS and transmitting entity from generating an EIRP that exceeds a requirement for radio frequency emissions, as further described herein.

While the examples depicted in FIG. 7 are described herein with respect to using multiple IRSs and/or multiple reflected paths for channel access to facilitate understanding, aspects of the present disclosure may also be applied to a single IRS providing one or more reflected paths for channel access. It will also be appreciated that the direct paths depicted in FIG. 7 may be representative of multipath propagation with reflections from water bodies or objects other than the IRSs.

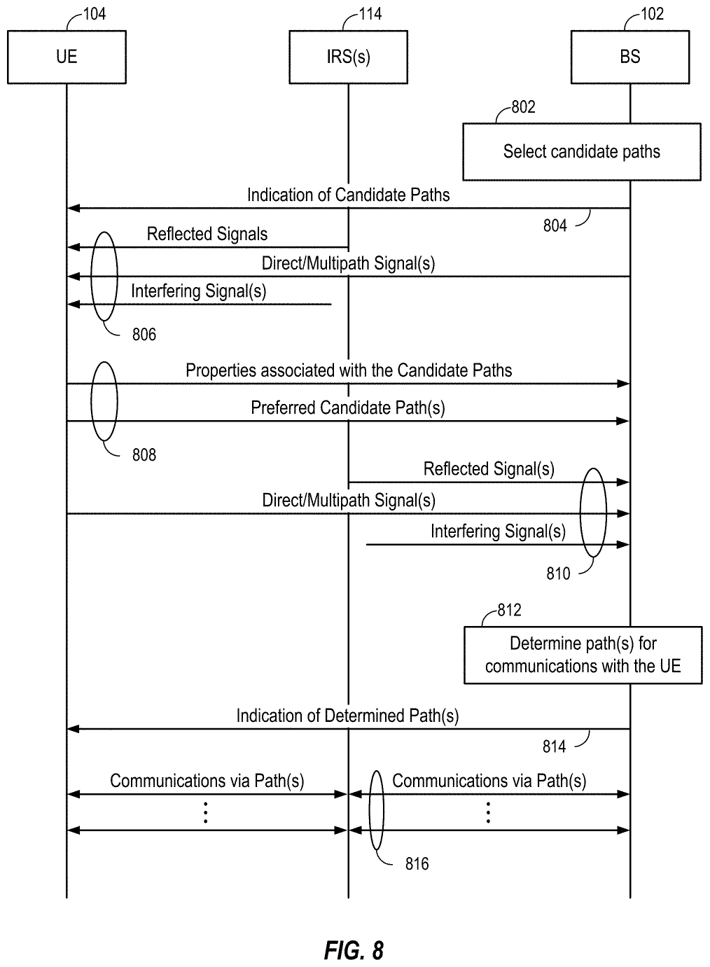

FIG. 8 is a signaling flow illustrating example signaling for providing channel access via one or more IRSs, in accordance with certain aspects of the present disclosure. At activity 802, the BS 102 may select candidate paths from a plurality of paths (e.g., a direct path, multipath, and/or reflected path(s) through an IRS) for the UE 104. The determination of the candidate paths may be based on considerations such as total path length (e.g., link delay) between the BS 102 and the UE 104, channel occupancy, channel measurements, the location of the UE 104 and/or IRS(s) 114, etc. In certain aspects, the candidate paths may be specific to a UE or common among multiple UEs. The BS 102 may select different candidate paths for different UEs.

At activity 804, the BS 102 may transmit, to the UE 104, an indication of the selected candidate paths to UE 104. In certain aspects, the BS 102 may provide an indication of the selected candidate paths through quasi co-location (QCL) assumptions (e.g., spatial assumptions or parameter(s)) associated with the candidate paths. The spatial assumption (e.g., spatial Rx parameters for QCL-TypeD) may be indicative of various spatial parameters for receive and/or transmit beamforming such as angle of arrival (AoA), AoA spread, dominant AoA, average AoA, Power Angular Spectrum (PAS) of AoA, angle of departure (AoD), AoD spread, average AoD, PAS of AoD, transmit/receive channel correlation, transmit/receive beamforming, spatial channel correlation, etc. The spatial QCL assumptions may enable a UE to determine a spatial filter (analog, digital, or hybrid) for beamforming a receive beam and/or a transmit beam. For certain aspects, a QCL assumption for a candidate path may be indicated with a transmission configuration indication (TCI) state indicative of the spatial parameter.

At activity 806, the UE 104 may measure properties associated with the candidate paths. For example, the UE 104 may measure signals (e.g., reference signals) received on the candidate paths, such as direct/multipath signals from the BS 102, interfering signals from other wireless nodes, and/or reflected signals from the IRS 114. The measured properties may include, for example, a channel quality indicator, a signal-to-noise ratio (SNR), a signal-to-interference plus noise ratio (SINR), a signal-to-noise plus distortion ratio (SNDR), a received signal strength indicator (RSSI), a reference signal received power (RSRP), a reference signal received quality (RSRQ), and/or a block error rate (BLER).

At activity 808, the UE 104 may transmit, to the BS 102, an indication of the properties associated with the candidate paths, an indication of one or more preferred paths among the candidate paths, or a combination thereof. For example, the UE 104 may send, to the BS 102, an indication of RSRPs associated with the preferred paths for communicating with the BS 102. The UE 104 may provide the properties associated with the candidate paths and/or preferred candidate paths on a periodic basis and/or in response to certain event(s), such as a request from the BS 102 and/or detecting a beam failure on a candidate path.

At activity 810, the BS 102 may measure properties associated with the candidate paths. For example, the BS 102 may measure signals received on the candidate paths, such as direct/multipath signals from the UE 104, interfering signals from other wireless nodes, and/or reflected signals from the IRS 114.

At activity 812, the BS 102 may determine one or more paths among the candidate paths for communicating with the UE 104. For example, the BS 102 may select the path(s) with the highest signal quality (e.g., highest RSRP) as measured at the UE 104 based on the received properties. In some cases, the BS 102 may select the preferred paths as provided by the UE 104 at activity 808.

At activity 814, the BS 102 may transmit, to the UE 104, an indication of the path(s) determined for communications between the UE 104 and BS 102. For example, the BS 102 may transmit scheduling (e.g., downlink control information (DCI) with a downlink resource grant) indicating the path(s) determined for communications.

At activity 816, the BS 102 may communicate with the UE 104 via the determined path(s). For example, the BS 102 may communicate with the UE 104 via multiple reflected paths (e.g., the reflected paths 714) through the IRS(s) 114. In some cases, the BS 102 may use path hopping to communicate with the UE 104, for example, where the BS 102 may communicate with the UE 104 in separate transmission occasions (e.g., one or more symbols) for each of the paths. In certain aspects, the BS 102 may communicate with the UE 104 using the path(s) through the IRS(s) 114 to enhance the received signals, for example, through constructive signal enhancement on the reflected paths of the IRS(s) 114.

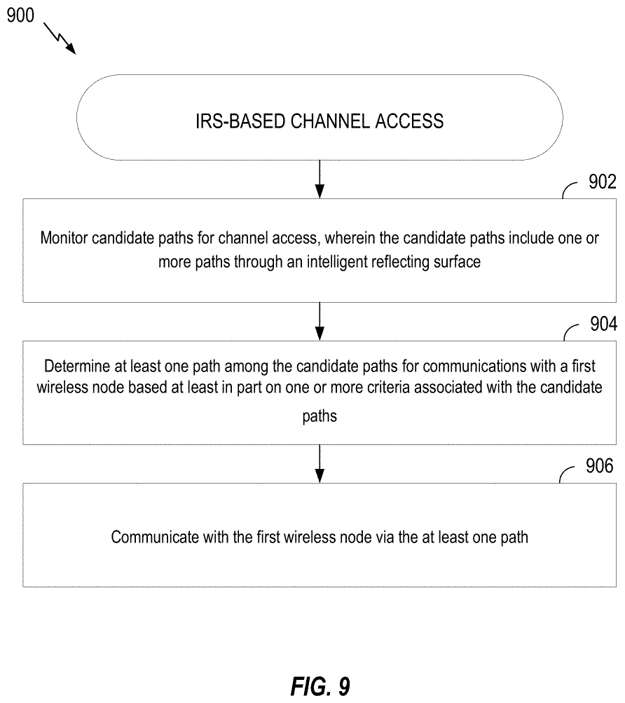

FIG. 9 is a flow diagram illustrating example operations 900 for wireless communication, in accordance with certain aspects of the present disclosure. The operations 900 may be performed, for example, by a network entity (such as the BS 102 in the wireless communication system 100 or the first wireless node 702 in the wireless communication network 700). The operations 900 may be implemented as software components that are executed and run on one or more processors (e.g., controller/processor 240 of FIG. 2). Further, the transmission and reception of signals by the network entity in operations 900 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals. As used herein, a network entity may refer to a wireless communication device in a radio access network, such as a base station, an access point, a remote radio head or antenna panel in communication with a base station, and/or a network controller.

The operations 900 may optionally begin, at block 902, where the network entity may monitor candidate paths for channel access, where the candidate paths may include one or more paths through an IRS, for example, as described herein with respect to FIG. 7. For example, the network entity may monitor whether a channel is busy or idle via the candidate paths based on channel measurements taken at the network entity and/or other wireless node(s). In certain aspects, the network entity may receive, from the first wireless node, signaling indicating one or more properties associated with the candidate paths, such as the measured properties described herein with respect to FIG. 8. For certain aspects, the network entity may measure one or more properties associated with the candidate paths, such as the measured properties described herein with respect to FIG. 8.

At block 904, the network entity may determine at least one path among the candidate paths for communications with a first wireless node (e.g., the UE 104 and/or the second wireless node 704) based at least in part on one or more criteria associated with the candidate paths and obtained from monitoring the candidate paths. The criteria may include measurements and/or properties associated with the candidate paths obtained at the network entity and/or at the first wireless node.

At block 906, the network entity may communicate with the first wireless node via the at least one path. Communicating may include transmitting and/or receiving signals. For example, the network entity may transmit, to the first wireless node, a signal via the path(s) determined at block 904. In some cases, the network entity may receive, from the first wireless node, a signal via the paths(s) at determined at block 904.

The network entity may evaluate various criteria or metrics in determining the path(s) for communications with the first wireless node. The criteria may include channel measurements associated with the candidate paths. The channel measurements may include, for example, a channel quality indicator, a SNR, a SINR, a SNDR, a RSSI, a RSRP), and/or a RSRQ. A channel measurement for a candidate path may be indicative of whether a candidate path is busy or idle and/or whether a receiving entity (e.g., the second wireless node 704) is encountering interference on the candidate path.

The criteria may include link delays associated with the candidate paths. The link delays may include a one-way delay time and/or a round-trip delay time between the network entity and the first wireless node. The link delays may be considered in determining whether an expected quality of service on the candidate path can be satisfied. For example, if a candidate path has a link delay that exceeds an expected latency, that particular candidate path may not be considered for communications between the network entity and the first wireless node. If a candidate path has a link delay that is less than or equal to an expected latency, that particular candidate path may be considered for communications between the network entity and the first wireless node.

The criteria may include channel occupancies associated with candidate paths. The channel occupancy may include a success/failure rate of channel access attempts, a channel busy ratio, and/or a channel occupancy ratio, for example. The channel occupancy may be measured before an access attempt by passively listening to the channel. The channel occupancy may be measured based on the failure of access attempts after an access attempt is made. The channel occupancy may be indicative of whether a candidate path is busy or idle and/or whether a receiving entity is encountering interference on the candidate path.

The criteria may include resource reservations or scheduling requests from one or more second wireless nodes (e.g., the third wireless node 706). For example, the network entity and/or first wireless node may receive resource reservations or scheduling requests from other wireless nodes. Based on the resource reservations and/or scheduling requests, the network entity may determine when the channel will be busy for a particular candidate path, and when a different candidate path may be provide an alternative communication link with no interference or reduced interference.

The criteria may include radiated powers (e.g., EIRPs) associated with one or more IRSs through which some of the candidate paths are formed. In certain cases, wireless devices operating in unlicensed bands may be subject to radio frequency (RF) emission requirements, such as a maximum transmit power, which may be evaluated in terms of EIRP. As an IRS reflects or refracts signals, the IRS may emit RF signals at a radiated power. The network entity may consider the radiated powers of the IRS(s) for the candidate paths and ensure the radiated powers are in compliance with the maximum transmit power allowed for unlicensed bands. The radiated powers may be determined using the position(s) of the network entity, the IRS, and/or the first wireless node; the transmit power at the transmitting entity (e.g., the network entity or the first wireless node); the surface area of the IRS; etc. The radiated power at the IRS may be adjusted by controlling the transmit power at the transmitting entity.

The criteria may include data error rates (e.g., BLER) associated with the candidate paths. The criteria may include any combination of the aforementioned examples of the criteria. The criteria may be obtained at the network entity and/or at the first wireless node and reported to the network entity. The criteria may include instantaneous measurements (e.g., RSRP at a particular instance in time), time-averaged measurements (e.g., RSRPs averaged over 500 milliseconds, 5 seconds, 10 seconds, etc.), or a combination thereof.

In certain aspects, the determination of the paths at block 904 may involve selecting the paths randomly, for example, with weights based on the criteria. In some cases, the determination of the paths at block 904 may involve selecting the paths deterministically based on time-averaged criteria. In certain aspects, the determination of the paths at block 904 may involve selecting the paths dynamically based on instantaneous criteria.

For certain aspects, the network entity may determine, for each of the candidate paths, a rank based at least in part on the criteria, and the network entity may determine the path(s) based on the ranks associated with the candidate paths. In certain cases, the network entity may select the path(s) with a highest rank among the ranks associated with the candidate paths. For example, the network entity may rank the candidate paths based on the RSRPs associated with the candidate paths, and the network entity may select the path(s) with the highest RSRP among the candidate paths based on the corresponding ranks. For certain cases, the network entity may select the path(s) randomly using weights associated with the candidate paths based on the ranks. The weight applied to a candidate path may correspond to the rank associated with the candidate path. For example, the highest rank may correspond to the greatest weight, and the lowest rank may correspond to the lowest weight. In certain aspects, the network entity may select the path(s) for communication with the first wireless node based on the properties associated with the candidate paths satisfying a threshold. For example, the network entity may select the paths that have RSRPs above a certain threshold.

The network entity may indicate the selected path(s) to the first wireless node, for example, as described herein with respect to FIG. 8. The network entity may transmit, to the first wireless node, scheduling indicating the path(s), and the network entity may communicate with the first wireless node based on the scheduling. The scheduling may include a DCI message indicating time-frequency resources and/or TCI state(s) for the transmission via the path(s). Each of the candidate paths may be associated with a spatial parameter (e.g., an angle of arrival and/or angle of departure). In certain cases, each of the candidate paths is associated with a TCI state indicative of the spatial parameter.

In certain aspects, the network entity may select the candidate paths from a plurality of paths, for example, as described herein with respect to FIG. 8. The network entity may transmit, to the first wireless node, an indication of the candidate paths. The network entity may receive, from the first wireless node, signaling indicating one or more properties associated with the candidate paths. The first wireless node may send the measured properties on a periodic basis and/or in response to certain event(s), for example.

For certain aspects, the network entity may communicate with the first wireless node with path hopping, for example, as described herein with respect to FIG. 8. As an example, the network entity may determine a plurality of paths among the candidate paths based at least in part on the criteria associated with the candidate paths, and the network entity may communicate with the first wireless node via the plurality of paths in separate transmission occasions (e.g., one or more symbols) for each of the plurality of paths.

In certain cases, the network entity may communicate with the first wireless node with multiple paths at the same time. As an example, the network entity may communicate with the first wireless node via the plurality of paths in the same transmission occasion for the plurality of paths, for example, with constructive signal enhancement via the IRS(s). In some cases, the network entity may use frequency division multiplexing and/or code division multiplexing to communicate with the first wireless node with multiple paths at the same time.

In certain aspects, there may be a plurality of IRSs for channel access, for example, as described herein with respect to FIG. 7. The candidate paths may include a plurality of paths, where each of the plurality of paths may be formed through a different IRS among a plurality of IRSs.

For certain aspects, the operations for IRS-based channel access may be specifically for channel access in an unlicensed spectrum. The network entity may communicate with the first wireless node in an unlicensed spectrum.

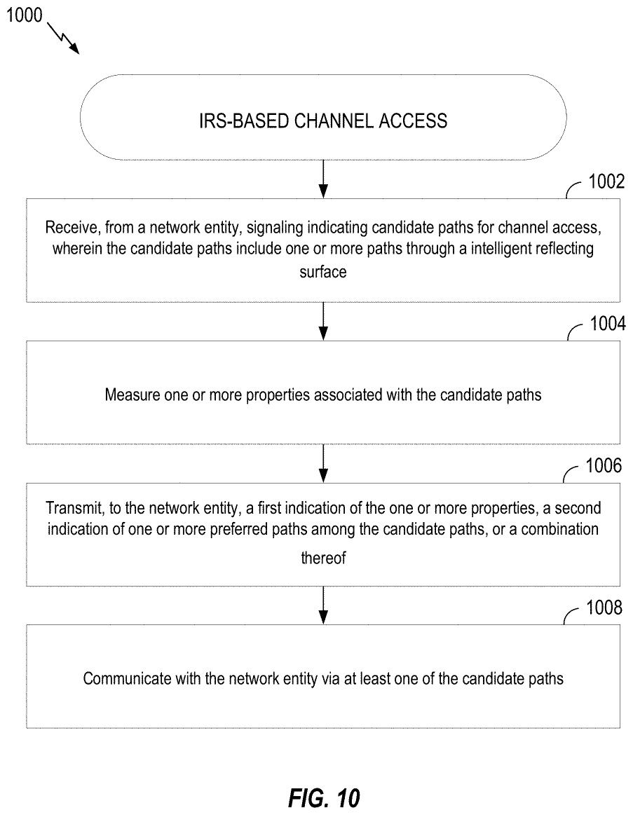

FIG. 10 is a flow diagram illustrating example operations 1000 for wireless communication, in accordance with certain aspects of the present disclosure. The operations 1000 may be performed, for example, by a first wireless node (such as the UE 104 in the wireless communication system 100). The operations 1000 may be complementary to the operations 900 performed by the network entity. The operations 1000 may be implemented as software components that are executed and run on one or more processors (e.g., controller/processor 280 of FIG. 2). Further, the transmission and reception of signals by the first wireless in operations 1000 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals. As used herein, a wireless node may refer to a wireless communication device in a radio access network, such as a user equipment or a wireless station.

The operations 1000 may optionally begin, at block 1002, where the first wireless node may receive, from a network entity (e.g., the BS 102), signaling indicating candidate paths for channel access. The candidate paths may include one or more paths through an IRS (e.g., the IRS 114), for example, as described herein with respect to FIG. 7. In certain aspects, the candidate paths may be indicated based on a spatial parameter (e.g., an angle of arrival, an angle of departure, or a TCI state) associated with each of the candidate paths, for example, as described herein with respect to FIGS. 8 and 9.

At block 1004, the first wireless node may measure one or more properties associated with the candidate paths. For example, the measured properties may include a channel quality indicator, a SNR, a SINR, a SNDR, a RSSI, a RSRP), a RSRQ, and/or a BLER. In certain cases, the measured properties may include metrics for channel occupancy, such as a success/failure rate of channel access attempts, a channel busy ratio, and/or a channel occupancy ratio.

At block 1006, the first wireless node may transmit, to the network entity, a first indication of the one or more properties, a second indication of one or more preferred paths among the candidate paths, or a combination thereof, for example, as described herein with respect to FIG. 8. In certain aspects, the first wireless node may determine the preferred paths based at least in part on one or more criteria associated with the candidate paths, for example, the criteria as described herein with respect to FIG. 9. In some cases, the first wireless may determine the preferred paths based on the criteria as described herein with respect to FIG. 9.

At block 1008, the first wireless node may communicate with the network entity via at least one of the candidate paths. Communicating may include transmitting and/or receiving signals. For example, the first wireless node may transmit, to the network entity, a signal via at least one of the candidate paths. In some cases, the first wireless node may receive, from the network entity, a signal via at least one of the candidate paths. The first wireless node may receive scheduling indicating the candidate paths selected for communications with the network entity. The scheduling may include a DCI message indicating time-frequency resources and/or TCI state(s) for the transmission via the path(s).

For certain aspects, the first wireless node may communicate with the network entity with path hopping, for example, as described herein with respect to FIG. 8. The first wireless node may communicate with the network entity via a plurality of the candidate paths in separate transmission occasions for each of the plurality of the candidate paths

In certain cases, the network entity may communicate with the first wireless node with multiple paths at the same time. The first wireless node may communicate with the network entity via a plurality of the candidate paths in a same transmission occasion for the plurality of the candidate paths. In some cases, the first wireless node may use frequency division multiplexing and/or code division multiplexing to communicate with the network entity with multiple paths at the same time.

In certain aspects, there may be a plurality of IRSs for channel access, for example, as described herein with respect to FIG. 7. For example, the candidate paths may include a plurality of paths, where each of the plurality of paths may be formed through a different IRS among a plurality of IRSs.

For certain aspects, the operations for IRS-based channel access may be specifically for channel access in an unlicensed spectrum. The first wireless node may communicate with the network entity in an unlicensed spectrum.

While the examples depicted in FIGS. 1-10 are described herein with respect to 5G NR systems (e.g., communications between a network entity and a wireless node) in an unlicensed spectrum to facilitate understanding, aspects of the present disclosure may also be applied to other radio access technologies (e.g., IEEE 802.11) and/or sidelink communications, such as V2X and/or D2D communications between UEs.

### Example Wireless Communication Devices

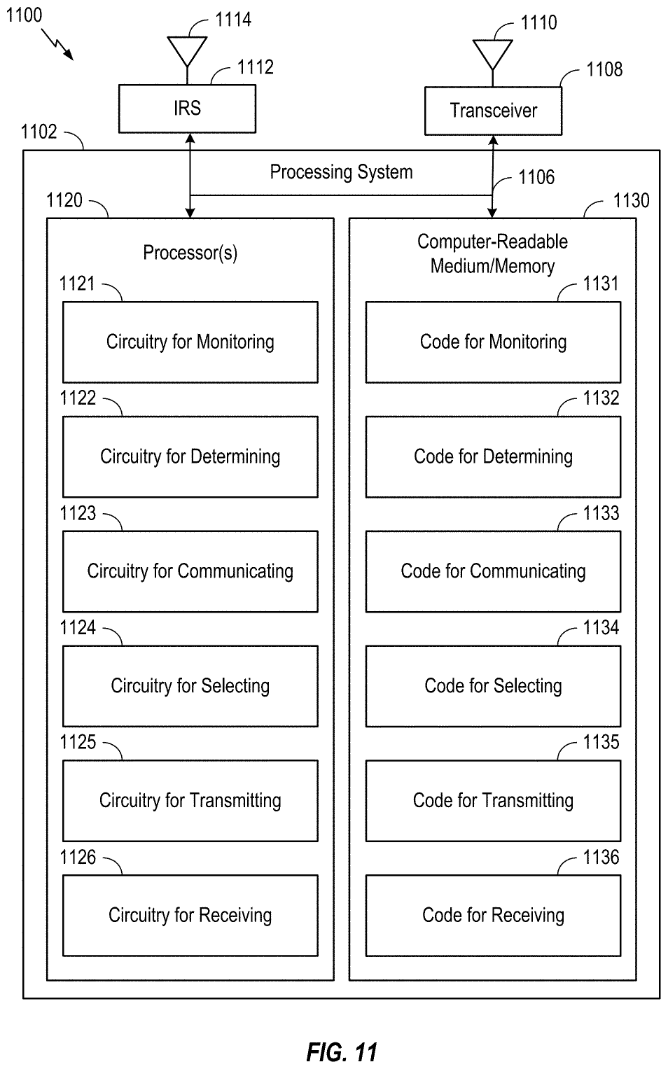

FIG. 11 depicts an example communications device 1100 that includes various components operable, configured, or adapted to perform operations for the techniques disclosed herein, such as the operations depicted and described with respect to FIGS. 7-9. In some examples, communication device 1100 may be a BS 102 or any other suitable wireless communication device, as described, for example with respect to FIGS. 1 and 2.

Communications device 1100 includes a processing system 1102 coupled to a transceiver 1108 (e.g., a transmitter and/or a receiver) and/or an IRS 1112 (e.g., a reflectarray and/or a metasurface). Transceiver 1108 is configured to transmit (or send) and receive signals for the communications device 1100 via an antenna 1110, such as the various signals as described herein. The IRS 1112 is configured to reflect and/or re-radiate signals for the communications device 1100 via an element 1114 (e.g., a reflection element or surface element), such as the various signals as described herein. Processing system 1102 may be configured to perform processing functions for communications device 1100, including processing signals received and/or to be transmitted by communications device 1100.

Processing system 1102 includes one or more processors 1120 coupled to a computer-readable medium/memory 1130 via a bus 1106. In certain aspects, computer-readable medium/memory 1130 is configured to store instructions (e.g., computer-executable code) that when executed by the one or more processors 1120, cause the one or more processors 1120 to perform the operations illustrated in FIGS. 7-9, or other operations for performing the various techniques discussed herein for IRS-based channel accessError! Reference source not found.

In the depicted example, computer-readable medium/memory 1130 stores code 1131 for monitoring, code 1132 for determining, code 1133 for communicating, code 1134 for selecting, code 1135 for transmitting, and/or code 1136 for receiving.

In the depicted example, the one or more processors 1120 include circuitry configured to implement the code stored in the computer-readable medium/memory 1130, including circuitry 1121 for monitoring, circuitry 1122 for determining, circuitry 1123 for communicating, circuitry 1124 for selecting, circuitry 1125 for transmitting, and/or circuitry 1126 for receiving.

Various components of communications device 1100 may provide means for performing the methods described herein, including with respect to FIGS. 7-9.

In some examples, means for transmitting or sending (or means for outputting for transmission) may include the transceivers 232 and/or antenna(s) 234 of the BS 102 illustrated in FIG. 2 and/or transceiver 1108 and antenna 1110 of the communication device 1100 in FIG. 11.

In some examples, means for receiving (or means for obtaining) may include the transceivers 232 and/or antenna(s) 234 of the base station illustrated in FIG. 2 and/or transceiver 1108 and antenna 1110 of the communication device 1100 in FIG. 11.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for monitoring, means determining, and/or means for selecting may include various processing system components, such as: the one or more processors 1120 in FIG. 11, or aspects of the BS 102 depicted in FIG. 2, including receive processor 238, transmit processor 220, TX MIMO processor 230, and/or controller/processor 240 (including the IRS-based channel access component 241).

Notably, FIG. 11 is an example, and many other examples and configurations of communication device 1100 are possible.

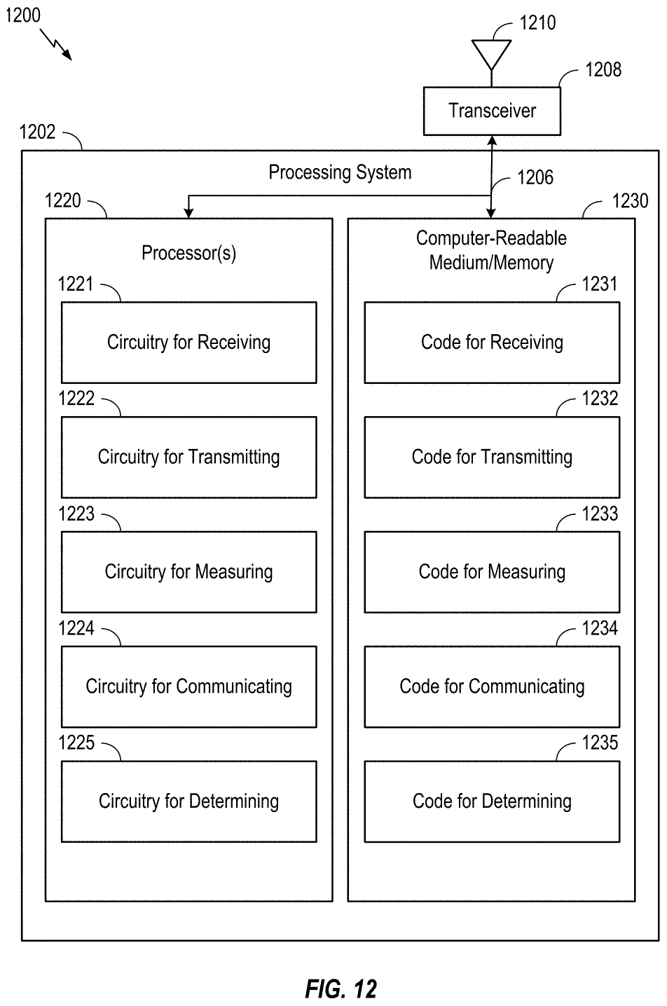

FIG. 12 depicts an example communications device 1200 that includes various components operable, configured, or adapted to perform operations for the techniques disclosed herein, such as the operations depicted and described with respect to FIGS. 7, 8, and 10. In some examples, communication device 1200 may be a UE 104 as described, for example with respect to FIGS. 1 and 2.

Communications device 1200 includes a processing system 1202 coupled to a transceiver 1208 (e.g., a transmitter and/or a receiver). Transceiver 1208 is configured to transmit (or send) and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes one or more processors 1220 coupled to a computer-readable medium/memory 1230 via a bus 1206. In certain aspects, computer-readable medium/memory 1230 is configured to store instructions (e.g., computer-executable code) that when executed by the one or more processors 1220, cause the one or more processors 1220 to perform the operations illustrated in FIGS. 7, 8, and 10, or other operations for performing the various techniques discussed herein for IRS-based channel access.

In the depicted example, computer-readable medium/memory 1230 stores code 1231 for receiving, code 1232 for transmitting, code 1233 for measuring, code 1234 for communicating, and/or code 1235 for determining.

In the depicted example, the one or more processors 1220 include circuitry configured to implement the code stored in the computer-readable medium/memory 1230, including circuitry 1221 for receiving, circuitry 1222 for transmitting, circuitry 1223 for measuring, circuitry 1224 for communicating, and/or circuitry 1225 for determining.

Various components of communications device 1200 may provide means for performing the methods described herein, including with respect to FIGS. 7, 8, and 10.

In some examples, means for transmitting or sending (or means for outputting for transmission) may include the transceivers 254 and/or antenna(s) 252 of the UE 104 illustrated in FIG. 2 and/or transceiver 1208 and antenna 1210 of the communication device 1200 in FIG. 12.

In some examples, means for receiving (or means for obtaining) may include the transceivers 254 and/or antenna(s) 252 of the UE 104 illustrated in FIG. 2 and/or transceiver 1208 and antenna 1210 of the communication device 1200 in FIG. 12.

In some examples, means for measuring and/or means for determining may include various processing system components, such as: the one or more processors 1220 in FIG. 12, or aspects of the UE 104 depicted in FIG. 2, including receive processor 258, transmit processor 264, TX MIMO processor 266, and/or controller/processor 280 (including the IRS-based channel access 281).

Notably, FIG. 12 is an example, and many other examples and configurations of communication device 1200 are possible.

### Example Aspects

Implementation examples are described in the following numbered clauses:

Aspect 1: An apparatus for wireless communication, comprising: a memory; and a processor coupled to the memory, the processor and the memory being configured to: monitor candidate paths for channel access, wherein the candidate paths include one or more paths through an intelligent reflecting surface, determine at least one path among the candidate paths for communications with a first wireless node based at least in part on one or more criteria associated with the candidate paths and obtained from monitoring the candidate paths, and communicate with the first wireless node via the at least one path.

Aspect 2: The apparatus of Aspect 1, wherein the one or more criteria comprises: channel measurements associated with the candidate paths; link delays associated with the candidate paths; channel occupancies associated with candidate paths; resource reservations or scheduling requests from one or more second wireless nodes; radiated powers associated with one or more intelligent reflecting surfaces through which some of the candidate paths are formed; data error rates associated with the candidate paths; or any combination thereof.

Aspect 3: The apparatus of Aspect 1 or 2, wherein the processor and the memory are further configured to receive, from the first wireless node, signaling indicating one or more properties associated with the candidate paths.

Aspect 4: The apparatus according to any of Aspects 1-3, wherein the processor and the memory are further configured to measure one or more properties associated with the candidate paths.

Aspect 5: The apparatus according to any of Aspects 1-4, wherein the processor and the memory are further configured to: determine, for each of the candidate paths, a rank based at least in part on the one or more criteria; and determine the at least on path based on the ranks associated with the candidate paths.

Aspect 6: The apparatus of Aspect 5, wherein the processor and the memory are further configured to select the at least one path randomly using weights associated with the candidate paths based on the ranks.

Aspect 7: The apparatus of Aspect 5 or 6, wherein the processor and the memory are further configured to select the at least one path with a highest rank among the ranks associated with the candidate paths.

Aspect 8: The apparatus according to any Aspects 1-8, wherein the one or more criteria includes instantaneous measurements, time-averaged measurements, or a combination thereof.

Aspect 9: The apparatus according to any of Aspects 1-8, wherein each of the candidate paths is associated with a spatial parameter.

Aspect 10: The apparatus of Aspect 9, wherein each of the candidate paths is associated with a transmission configuration indication (TCI) state indicative of the spatial parameter.

Aspect 11: The apparatus according to any of Aspects 1-10, wherein the processor and the memory are further configured to: select the candidate paths from a plurality of paths; transmit, to the first wireless node, an indication of the candidate paths; and receive, from the first wireless node, signaling indicating one or more properties associated with the candidate paths.

Aspect 12: The apparatus according to any of Aspects 1-11, wherein the processor and the memory are further configured to: transmitting, to the first wireless node, scheduling indicating the at least one path; and wherein communicating with the first wireless node comprises communicating with the first wireless node based on the scheduling.

Aspect 13: The apparatus according to any of Aspects 1-12, wherein the processor and the memory are further configured to: determine a plurality of paths among the candidate paths based at least in part on the one or more criteria associated with the candidate paths; and communicate with the first wireless node via the plurality of paths in separate transmission occasions for each of the plurality of paths or in a same transmission occasion for the plurality of paths.

Aspect 14: The apparatus according to any of Aspects 1-13, wherein: the candidate paths include a plurality of paths; and each of the plurality of paths is formed through a different intelligent reflecting surface among a plurality of intelligent reflecting surfaces.

Aspect 15: The apparatus according to any of Aspects 1-14, wherein the processor and the memory are further configured to communicate with the first wireless node in an unlicensed spectrum.

Aspect 16: An apparatus for wireless communication, comprising: a memory; and a processor coupled to the memory, the processor and the memory are further configured to: receive, from a network entity, signaling indicating candidate paths for channel access, wherein the candidate paths include one or more paths through an intelligent reflecting surface, measure one or more properties associated with the candidate paths, transmit, to the network entity, a first indication of the one or more properties, a second indication of one or more preferred paths among the candidate paths, or a combination thereof, and communicate with the network entity via at least one of the candidate paths.

Aspect 17: The apparatus of Aspect 16, wherein the processor and the memory are further configured to determine the one or more preferred paths based at least in part on one or more criteria associated with the candidate paths.

Aspect 18: The apparatus of Aspect 17, wherein the one or more criteria comprises: channel measurements associated with the candidate paths; link delays associated with the candidate paths; channel occupancies associated with candidate paths; resource reservations or scheduling requests from one or more wireless nodes; radiated powers associated with one or more intelligent reflecting surfaces through which some of the candidate paths are formed; data error rates associated with the candidate paths; or any combination thereof.

Aspect 19: The apparatus according to any of Aspects 16-18, wherein each of the candidate paths is associated with a spatial parameter.

Aspect 20: The apparatus of Aspect 19, wherein each of the candidate paths is associated with a transmission configuration indication (TCI) state indicative of the spatial parameter.

Aspect 21: The apparatus according to any of Aspects 16-20, wherein the processor and the memory are further configured to: receive, from the network entity, scheduling indicating the at least one of the candidate paths; and communicate with the network entity based on the scheduling.

Aspect 22: The apparatus according to any of Aspects 16-21, wherein the processor and the memory are further configured to communicate with the network entity via a plurality of the candidate paths in separate transmission occasions for each of the plurality of the candidate paths or in a same transmission occasion for the plurality of the candidate paths.

Aspect 23: The apparatus according to any of Aspects 16-22, wherein: the candidate paths include a plurality of paths; and each of the plurality of paths is formed through a different intelligent reflecting surface among a plurality of intelligent reflecting surfaces.

Aspect 24: The apparatus according to any of Aspects 16-23, wherein the processor and the memory are further configured to communicate with the network entity in an unlicensed spectrum.

Aspect 25: A method of wireless communication by a network entity, comprising: monitoring candidate paths for channel access, wherein the candidate paths include one or more paths through an intelligent reflecting surface; determining at least one path among the candidate paths for communications with a first wireless node based at least in part on one or more criteria associated with the candidate paths and obtained from monitoring the candidate paths; and communicating with the first wireless node via the at least one path.

Aspect 26: The method of Aspect 25, wherein the one or more criteria comprises: channel measurements associated with the candidate paths; link delays associated with the candidate paths; channel occupancies associated with candidate paths; resource reservations or scheduling requests from one or more second wireless nodes; radiated powers associated with one or more intelligent reflecting surfaces through which some of the candidate paths are formed; data error rates associated with the candidate paths; or any combination thereof.

Aspect 27: The method of Aspect 25 or 26, wherein monitoring the candidate paths comprises receiving, from the first wireless node, signaling indicating one or more properties associated with the candidate paths.

Aspect 28: The method according to any of Aspects 25-27, wherein monitoring the candidate paths comprises measuring one or more properties associated with the candidate paths.

Aspect 29: The method according to any of Aspects 25-28, wherein determining the at least one path comprises: determining, for each of the candidate paths, a rank based at least in part on the one or more criteria; and determining the at least on path based on the ranks associated with the candidate paths.

Aspect 30: The method of Aspect 29, wherein determining the at least one path comprises selecting the at least one path randomly using weights associated with the candidate paths based on the ranks.

Aspect 31: The method of Aspect 29 or 30, wherein determining the at least one path comprises selecting the at least one path with a highest rank among the ranks associated with the candidate paths.

Aspect 32: The method according to any of Aspects 25-31, wherein the one or more criteria includes instantaneous measurements, time-averaged measurements, or a combination thereof.

Aspect 33: The method according to any of Aspects 25-32, wherein each of the candidate paths is associated with a spatial parameter.

Aspect 34: The method of Aspect 33, wherein each of the candidate paths is associated with a transmission configuration indication (TCI) state indicative of the spatial parameter.

Aspect 35: The method according to any of Aspects 25-34, further comprising: selecting the candidate paths from a plurality of paths; transmitting, to the first wireless node, an indication of the candidate paths; and receiving, from the first wireless node, signaling indicating one or more properties associated with the candidate paths.

Aspect 36: The method according to any of Aspects 25-35, further comprising: transmitting, to the first wireless node, scheduling indicating the at least one path; and wherein communicating with the first wireless node comprises communicating with the first wireless node based on the scheduling.

Aspect 37: The method according to any of Aspects 25-36, wherein: determining the at least one path among the candidate paths comprises determining a plurality of paths among the candidate paths based at least in part on the one or more criteria associated with the candidate paths; and communicating with the first wireless node comprises communicating with the first wireless node via the plurality of paths in separate transmission occasions for each of the plurality of paths or in a same transmission occasion for the plurality of paths.

Aspect 38: The method according to any of Aspects 25-37, wherein: the candidate paths include a plurality of paths; and each of the plurality of paths is formed through a different intelligent reflecting surface among a plurality of intelligent reflecting surfaces.

Aspect 39: The method according to any of Aspects 25-38, wherein communicating with the first wireless node comprises communicating with the first wireless node in an unlicensed spectrum.

Aspect 40: A method of wireless communication by a first wireless node, comprising: receiving, from a network entity, signaling indicating candidate paths for channel access, wherein the candidate paths include one or more paths through an intelligent reflecting surface; measuring one or more properties associated with the candidate paths; transmitting, to the network entity, a first indication of the one or more properties, a second indication of one or more preferred paths among the candidate paths, or a combination thereof; and communicating with the network entity via at least one of the candidate paths.

Aspect 41: The method of Aspect 40, further comprising determining the one or more preferred paths based at least in part on one or more criteria associated with the candidate paths.

Aspect 42: The method of Aspect 41, wherein the one or more criteria comprises: channel measurements associated with the candidate paths; link delays associated with the candidate paths; channel occupancies associated with candidate paths; resource reservations or scheduling requests from one or more second wireless nodes; radiated powers associated with one or more intelligent reflecting surfaces through which some of the candidate paths are formed; data error rates associated with the candidate paths; or any combination thereof.

Aspect 43: The method according to any of Aspects 40-42, wherein each of the candidate paths is associated with a spatial parameter.

Aspect 44: The method of Aspect 43, wherein each of the candidate paths is associated with a transmission configuration indication (TCI) state indicative of the spatial parameter.

Aspect 45: The method according to any of Aspects 40-44, further comprising: receiving, from the network entity, scheduling indicating the at least one of the candidate paths; and wherein communicating with the network entity comprises communicating with the network entity based on the scheduling.

Aspect 46: The method according to any of Aspects 40-45, wherein: communicating with the network entity comprises communicating with the network entity via a plurality of the candidate paths in separate transmission occasions for each of the plurality of the candidate paths or in a same transmission occasion for the plurality of the candidate paths.

Aspect 47: The method according to any of Aspects 40-46, wherein: the candidate paths include a plurality of paths; and each of the plurality of paths is formed through a different intelligent reflecting surface among a plurality of intelligent reflecting surfaces.

Aspect 48: The method according to any of Aspects 40-47, wherein communicating with the network entity comprises communicating with the network entity in an unlicensed spectrum.

Aspect 49: An apparatus, comprising: a memory comprising executable instructions; and one or more processors configured to execute the executable instructions and cause the apparatus to perform a method in accordance with any of Aspects 25-48.

Aspect 50: An apparatus, comprising means for performing a method in accordance with any of Aspects 25-48.

Aspect 51: A non-transitory computer-readable medium comprising executable instructions that, when executed by one or more processors of an apparatus, cause the apparatus to perform a method in accordance with any of Aspects 25-48.

Aspect 52: A computer program product embodied on a computer-readable storage medium comprising code for performing a method in accordance with any of Aspects 25-48.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=15 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of wirelessly communicating with an intelligent reflecting surface in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. In some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
a memory; and
a processor coupled to the memory, the processor and the memory being configured to:
monitor candidate paths for channel access, wherein the candidate paths include one or more paths through an intelligent reflecting surface,
determine at least one path among the candidate paths for communications with a first wireless node based at least in part on one or more criteria associated with the candidate paths and obtained from monitoring the candidate paths, and
communicate with the first wireless node via the at least one path.

2. The apparatus of claim 1, wherein the one or more criteria comprises:
channel measurements associated with the candidate paths;
link delays associated with the candidate paths;
channel occupancies associated with candidate paths;
resource reservations or scheduling requests from one or more second wireless nodes;
radiated powers associated with one or more intelligent reflecting surfaces through which some of the candidate paths are formed;
data error rates associated with the candidate paths; or
any combination thereof.

3. The apparatus of claim 1, wherein the processor and the memory are further configured to receive, from the first wireless node, signaling indicating one or more properties associated with the candidate paths.

4. The apparatus of claim 1, wherein the processor and the memory are further configured to measure one or more properties associated with the candidate paths.

5. The apparatus of claim 1, wherein the processor and the memory are further configured to:
determine, for each of the candidate paths, a rank based at least in part on the one or more criteria; and
determine the at least on path based on the ranks associated with the candidate paths.

6. The apparatus of claim 5, wherein the processor and the memory are further configured to select the at least one path randomly using weights associated with the candidate paths based on the ranks.

7. The apparatus of claim 5, wherein the processor and the memory are further configured to select the at least one path with a highest rank among the ranks associated with the candidate paths.

8. The apparatus of claim 1, wherein the one or more criteria includes instantaneous measurements, time-averaged measurements, or a combination thereof.

9. The apparatus of claim 1, wherein each of the candidate paths is associated with a spatial parameter.

10. The apparatus of claim 9, wherein each of the candidate paths is associated with a transmission configuration indication (TCI) state indicative of the spatial parameter.

11. The apparatus of claim 1, wherein the processor and the memory are further configured to:
select the candidate paths from a plurality of paths;
transmit, to the first wireless node, an indication of the candidate paths; and
receive, from the first wireless node, signaling indicating one or more properties associated with the candidate paths.

12. The apparatus of claim 1, wherein the processor and the memory are further configured to:
transmitting, to the first wireless node, scheduling indicating the at least one path; and
wherein communicating with the first wireless node comprises communicating with the first wireless node based on the scheduling.

13. The apparatus of claim 1, wherein the processor and the memory are further configured to:
determine a plurality of paths among the candidate paths based at least in part on the one or more criteria associated with the candidate paths; and
communicate with the first wireless node via the plurality of paths in separate transmission occasions for each of the plurality of paths or in a same transmission occasion for the plurality of paths.

14. The apparatus of claim 1, wherein:
the candidate paths include a plurality of paths; and
each of the plurality of paths is formed through a different intelligent reflecting surface among a plurality of intelligent reflecting surfaces.

15. The apparatus of claim 1, wherein the processor and the memory are further configured to communicate with the first wireless node in an unlicensed spectrum.

16. An apparatus for wireless communication, comprising:
a memory; and
a processor coupled to the memory, the processor and the memory are further configured to:
receive, from a network entity, signaling indicating candidate paths for channel access, wherein the candidate paths include one or more paths through an intelligent reflecting surface,
measure one or more properties associated with the candidate paths,
transmit, to the network entity, a first indication of the one or more properties, a second indication of one or more preferred paths among the candidate paths, or a combination thereof, and
communicate with the network entity via at least one of the candidate paths.

17. The apparatus of claim 16, wherein the processor and the memory are further configured to determine the one or more preferred paths based at least in part on one or more criteria associated with the candidate paths.

18. The apparatus of claim 17, wherein the one or more criteria comprises:
channel measurements associated with the candidate paths;
link delays associated with the candidate paths;
channel occupancies associated with candidate paths;
resource reservations or scheduling requests from one or more wireless nodes;
radiated powers associated with one or more intelligent reflecting surfaces through which some of the candidate paths are formed;
data error rates associated with the candidate paths; or
any combination thereof.

19. The apparatus of claim 16, wherein each of the candidate paths is associated with a spatial parameter.

20. The apparatus of claim 19, wherein each of the candidate paths is associated with a transmission configuration indication (TCI) state indicative of the spatial parameter.

21. The apparatus of claim 16, wherein the processor and the memory are further configured to:
receive, from the network entity, scheduling indicating the at least one of the candidate paths; and
communicate with the network entity based on the scheduling.

22. The apparatus of claim 16, wherein the processor and the memory are further configured to communicate with the network entity via a plurality of the candidate paths in separate transmission occasions for each of the plurality of the candidate paths or in a same transmission occasion for the plurality of the candidate paths.

23. The apparatus of claim 16, wherein:
the candidate paths include a plurality of paths; and
each of the plurality of paths is formed through a different intelligent reflecting surface among a plurality of intelligent reflecting surfaces.

24. The apparatus of claim 16, wherein the processor and the memory are further configured to communicate with the network entity in an unlicensed spectrum.

25. A method of wireless communication by a network entity, comprising:
monitoring candidate paths for channel access, wherein the candidate paths include one or more paths through an intelligent reflecting surface;
determining at least one path among the candidate paths for communications with a first wireless node based at least in part on one or more criteria associated with the candidate paths and obtained from monitoring the candidate paths; and
communicating with the first wireless node via the at least one path.

26. The method of claim 25, wherein the one or more criteria comprises:
channel measurements associated with the candidate paths;
link delays associated with the candidate paths;
channel occupancies associated with candidate paths;
resource reservations or scheduling requests from one or more second wireless nodes;
radiated powers associated with one or more intelligent reflecting surfaces through which some of the candidate paths are formed;
data error rates associated with the candidate paths; or
any combination thereof.

27. The method of claim 25, wherein determining the at least one path comprises:
determining, for each of the candidate paths, a rank based at least in part on the one or more criteria; and
determining the at least on path based on the ranks associated with the candidate paths.

28. A method of wireless communication by a first wireless node, comprising:
receiving, from a network entity, signaling indicating candidate paths for channel access, wherein the candidate paths include one or more paths through an intelligent reflecting surface;
measuring one or more properties associated with the candidate paths;
transmitting, to the network entity, a first indication of the one or more properties, a second indication of one or more preferred paths among the candidate paths, or a combination thereof; and
communicating with the network entity via at least one of the candidate paths.

29. The method of claim 28, further comprising determining the one or more preferred paths based at least in part on one or more criteria associated with the candidate paths.

30. The method of claim 29, wherein the one or more criteria comprises:
channel measurements associated with the candidate paths;
link delays associated with the candidate paths;
channel occupancies associated with candidate paths;
resource reservations or scheduling requests from one or more second wireless nodes;
radiated powers associated with one or more intelligent reflecting surfaces through which some of the candidate paths are formed;
data error rates associated with the candidate paths; or
any combination thereof.
